(19) United States
(12) Patent Application Publication
(10) Pub. No.: US 2026/0135620 A1
(43) Pub. Date: May 14, 2026

(54) Coherent Modulation-Free Photonic Active (COMPACT) Stabilization Specification

(71) Applicant: U.S. Army DEVCOM, Army Research Laboratory, Adelphi, MD (US)

(72) Inventor: James P. Cahill, Columbia, MD (US)

(73) Assignee: U.S. Government, as Represented by Secretary of the Army, Adelphi, MD (US)

(21) Appl. No.: 18/947,361

(22) Filed: Nov. 14, 2024

(51) Int. Cl. H04B 10/50

(52) U.S. Cl. CPC H04B 10/502

(57) ABSTRACT

COherent Modulation-free Photonic ACTive (or “COMPACT”) Stabilization is described. The COMPACT stabilization provides significant improvement relative to a traditional Pound-Drever-Hall (PDH) technique, which may be used to lock light sources (such as lasers) to optical cavities (and/or locking optical cavities to light sources). COMPACT stabilization may include or otherwise utilize a second light source that functionally replaces an external microwave source of existing PDH stabilizers. COMPACT stabilization may provide noiseless gain to the locking error signal, thereby increasing the sensitivity and improving the performance of the stabilizer.

### GOVERNMENT INTEREST

The invention described herein may be manufactured, used and licensed by or for the U.S. Government.

### BACKGROUND OF THE INVENTION

Existing laser stabilization solutions require elements such as an external microwave source to modulate the laser.

Thus, there is a need for stabilization that is able to be implemented without using an external modulation source.

### BRIEF SUMMARY OF THE INVENTION

Some embodiments of the invention provide COherent Modulation-free Photonic ACTive (or “COMPACT”) Stabilization. The COMPACT stabilization provides significant improvement relative to a traditional Pound-Drever-Hall (PDH) technique, which may be used to lock lasers to optical cavities (and/or locking optical cavities to lasers). COMPACT stabilization of some embodiments may include or otherwise utilize a second laser that functionally replaces an external microwave source of existing PDH stabilizers. COMPACT stabilization may provide noiseless gain to the locking error signal, thereby increasing the sensitivity and improving the performance of the stabilizer.

COMPACT stabilization of some embodiments may utilize a real-time measurement of the frequency difference between a first laser and a frequency reference point established via a frequency-dependent optical element (FDOE). The measured frequency difference may be used to match (i.e., be equal to) the frequency of the laser to that of the FDOE (or vice-versa). COMPACT stabilization allows the real-time measurement to be performed without modulation of the first laser by the introduction of the second laser, which may act as a local oscillator.

The components and operation of a COMPACT stabilization device, system, set(s) of component(s), and/or other type of implementation (herein referred to as “COMPACT stabilizers”) may provide a number of advantages over a traditional PDH system. In contrast to previous implementations of PDH for example, COMPACT stabilization does not achieve optical phase sensitive detection by modulating the input laser with an external microwave source. Instead, COMPACT stabilization achieves optical phase sensitive detection by mixing the input laser with a second laser. This approach has several distinct advantages over previous implementations of PDH, including the elimination of external electronic frequency sources and modulators as well as improved sensitivity through the use of optical coherent detection with a second laser.

COMPACT stabilization may be used in applications such as: physical sensors (e.g., temperature, vibration, strain, acoustic, etc.), biological sensors, chemical sensors (e.g., spectroscopy sensors), light detection and ranging (LIDAR) or radio detection and ranging (RADAR), clocks and/or frequency references in next-generation communications networks (e.g., 6G and beyond), other sensors based on detection of optical phase or frequency shifts (e.g., magnetic field sensors, gyroscopes, etc.), optical clocks, and/or other appropriate applications.

COMPACT stabilization may compare the frequency of a laser to a frequency reference point that is generated by an FDOE. Using COMPACT stabilization, the laser frequency may be locked to frequency reference point of the FDOE or the frequency reference point of the FDOE can be locked to the laser frequency. The term “FDOE” is used herein in a generalized sense, and may refer to any optical device that imparts a frequency-dependent response (e.g., an optical delay line, a ring resonator, an optical grating, etc.).

### BRIEF DESCRIPTION OF DRAWINGS

The novel features of the disclosure are set forth in the appended claims. However, for purposes of explanation, several embodiments are illustrated in the following drawings.

FIG. 1 illustrates a schematic block diagram of a first coherent modulation-free photonic active (COMPACT) stabilizer of one or more embodiments described herein;

FIG. 2 illustrates a schematic block diagram of a second COMPACT stabilizer of one or more embodiments described herein;

FIG. 3 illustrates a schematic block diagram of a third COMPACT stabilizer of one or more embodiments described herein;

FIG. 4 illustrates a schematic block diagram of a fourth COMPACT stabilizer of one or more embodiments described herein;

FIG. 5 illustrates a schematic block diagram of a fifth COMPACT stabilizer of one or more embodiments described herein;

FIG. 6 illustrates a schematic block diagram of a sixth COMPACT stabilizer of one or more embodiments described herein;

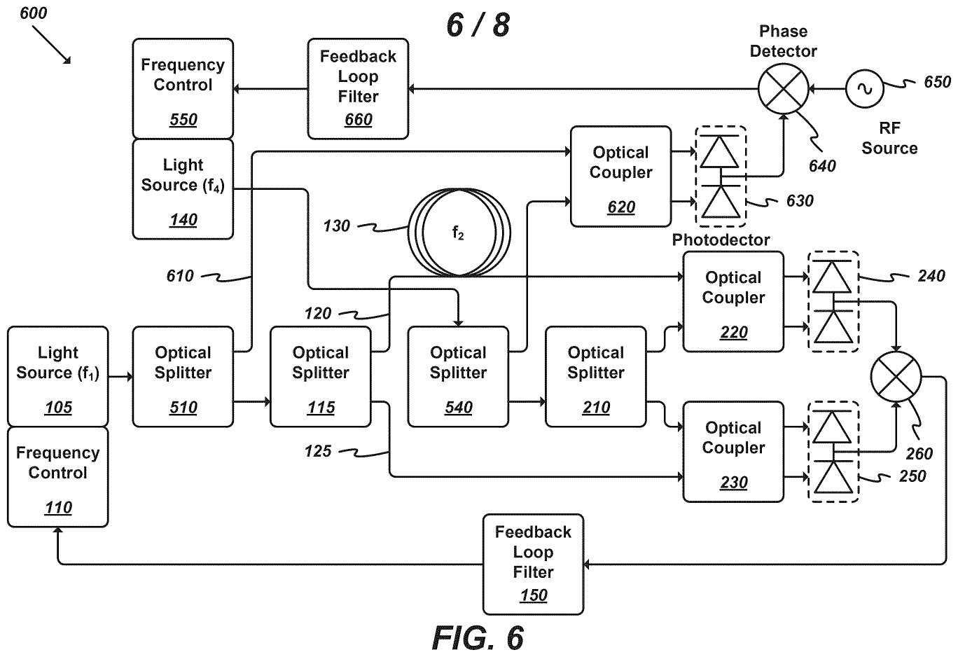

FIG. 7 illustrates a schematic block diagram of a seventh COMPACT stabilizer of one or more embodiments described herein; and

FIG. 8 illustrates a schematic block diagram of an eighth COMPACT stabilizer of one or more embodiments described herein.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide COMPACT stabilization of a laser with respect to an FDOE (or vice-versa). The stabilization may be implemented using a second laser that operates at a different frequency than the first laser. The second laser may obviate the need for an external modulator as required by existing solutions. Optical splitters and/or couplers may be utilized to compare the outputs of the first laser and the second laser and generate a feedback signal that at least partially controls the frequency of the first laser.

COMPACT stabilization may lock a laser to an FDOE such as a resonator, grating, cavity, or delay line, by sensing the optical phase and amplitude change that the FDOE imparts on the laser. Existing PDH systems must convert the laser signal to an electronic signal while preserving the optical phase, where the phase-sensitive detection is achieved by modulating the laser with an electronic signal.

COMPACT stabilization has various advantages over existing solutions. COMPACT stabilization does not require external modulation and hence does not require a low-noise electronic oscillator to generate the external modulation signal, which is particularly salient on an integrated photonic platform, where electronic oscillators and high-speed modulators (e.g., having bandwidths greater than ten kHz) may not be available. Coherent detection using a second laser increases sensitivity, which is also particularly salient on an integrated photonic platform, because losses coupling on and off the photonic integrated circuit (PIC) are generally relatively large (e.g., three dB per facet) and optical amplifiers are generally not available on PICs. COMPACT stabilization techniques, in contrast, are able to be implemented on PICs or with low-Q optical cavities.

The error signal utilized by COMPACT stabilization is always equivalent to the more desirable “fast modulation” error signal in traditional PDH loops, even when the resonance is so wide that a fast modulation signal would be at an impractically high frequency (e.g., one hundred GHz). In COMPACT stabilization, the optical resonators may be replaced with optical delay lines due to the interferometer-like architecture. If the first laser is a pulsed or multi-frequency source (e.g., an optical frequency comb or mode-locked laser), COMPACT stabilization naturally allows one of the frequencies to be unambiguously compared to the FDOE frequency.

Previous variations of PDH may be challenging to implement in a PIC, because traditional PDH requires an external radio frequency or microwave frequency source. Such sources may not be available in commercial integrated photonic platforms. Furthermore, traditional PDH circuits frequently use external phase or amplitude modulators, which may also be unavailable in commercial integrated photonic platforms. Even if frequency sources and modulators were available, integrated photonic resonators often have wider linewidths than their discrete counterparts, which in turn means that the frequency source and modulator bandwidth can reach magnitudes (e.g., greater than ten GHz) that are challenging or impractical to realize even in stand-alone components. COMPACT stabilization addresses all of these challenges by achieving a similar optical-phase-sensitive detection to traditional PDH circuits without requiring any radio-or microwave frequency modulation.

Traditional PDH circuits may also suffer from limited sensitivity when the input laser has a relatively low power. This situation is frequently encountered in integrated photonic systems, where optical amplification is not readily available, and coupling losses are non-negligible. COMPACT stabilization addresses this challenge by taking advantage of the coherent gain provided by the second laser.

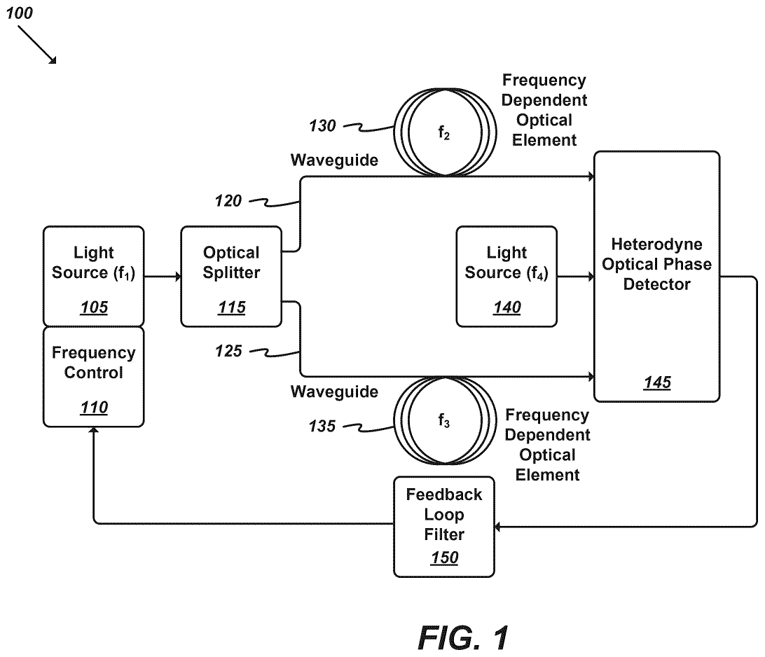

FIG. 1 illustrates a schematic block diagram of a first COMPACT stabilizer 100 of one or more embodiments described herein. As shown, the first COMPACT stabilizer 100 may include a first light source 105, a frequency control 110, a first optical splitter 115, a first waveguide 120, a second waveguide 125, a first FDOE 130, a second FDOE 135, a second light source 140, a heterodyne optical phase detector 145, and a feedback loop filter 150.

COMPACT stabilizer 100 may be implemented by, via, and/or otherwise utilizing various components, devices, systems, and/or other resources as appropriate. In some embodiments, the components associated with COMPACT stabilizer 100 may be implemented as components of a PIC.

First light source 105 may be a light emitting device, component, or other resource that is able to produce light at a specified frequency (f₁) (e.g., a single frequency laser, a photon source, a light-emitting diode (LED), etc.), or set of frequencies in the case of a multi-frequency laser or other multi-frequency source (e.g., an optical frequency comb or mode-locked laser). frequency over a given range associated with the first light source 105. Frequency control 110 may vary parameters or attributes such as drive current or drive voltage, signal type, signal frequency, etc. that may cause the specified frequency (f₁) to change in response. Second light source 140 may be similar to first light source 105, except that the specified frequency (f₄) may be different than specified frequency (f₁).

First optical splitter 115 (or “beam” splitter) may distribute optical power among multiple outputs (e.g., two outputs in this example). Second optical splitter 140 may be similar to first optical splitter 115.

First waveguide 120 may be, include, and/or otherwise utilize a physical structure that guides electromagnetic waves in the optical spectrum. Second waveguide 125 may be similar to first waveguide 125 (of course, in this configuration second waveguide 125 is not associated with any FDOE).

First FDOE 130 may be any type of optical element that has a frequency dependency, such as a cavity resonator, atomic reference, or optical delay line. In this example, first FDOE 130 is associated with a specified frequency (f₂). Examples of such elements include optical cavity resonators that may include an arrangement of mirrors and/or other optical elements that may form a cavity resonator for light waves. Second FDOE 135 may be similar to first FDOE 130, except that the specified frequency (f₃) may be different than specified frequency (f₂).

Heterodyne optical phase detector 145 may be able to detect phase and/or frequency information associated with received light signals.

Feedback loop filter 150 may condition or filter the received signal in various appropriate ways (e.g., high-pass filtering, low-pass filtering, band-pass filtering, active filtering, etc.) to achieve a stable feedback signal to drive frequency control 110.

In the example COMPACT stabilizer 100, the frequency of the first light source 105 (f₁) may be locked to the frequency of the first FDOE 130 (f₂). The frequency of the first light source 105 (f₁) may be tuned via modulation of an internal light source parameter (e.g., a laser pump current or laser cavity length) or an external modulator (e.g., an acousto-optic frequency shifter).

The first light source 105 may be split by the first optical splitter 115 such that a portion of the light travels via first waveguide 120 and another portion of the light travels via second waveguide 125. The amplitude and phase of the light traveling via first waveguide 120 may be altered by first FDOE 130 by an amount that depends on the frequency of the first light source 105 (f₁). The amplitude and phase of the light traveling via second waveguide 125 remain unaltered.

If the optical phase difference between the light traveling via the first waveguide 120 and the second waveguide 125 were quantified the signal would pass zero at certain frequencies. These zero crossings would correspond to the frequency reference points of the first FDOE 130 and constitute points where an active feedback loop can be closed to lock the frequency of the first light source 105 (f₁). When the first FDOE 130 is a resonant device, the amplitude of the light traveling via the first waveguide 120 usually also approaches zero at the frequency reference points, which enhances the signal in the feedback loop.

The second light source 140 may be used to detect the optical phase difference between the light traveling via first waveguide 120 and second waveguide 125. The second light source 140 may generate an optical signal to be used as a temporary optical phase reference and for additional signal gain. The light from the second light source 140 may be provided to the heterodyne optical phase detector, as shown. Similarly, the light traveling along the first waveguide 120 and the second waveguide 125 may be provided to the heterodyne optical phase detector 145.

Heterodyne optical phase detector 145 may receive the outputs of second light source 140, waveguide 120, and waveguide 125. Crucially, because the second light source 140 is used to down-convert both of the electronic signals, any contribution to the output signal from the second light source 140 is canceled out. The heterodyne optical phase detector 145 may provide an error signal output, which may be passed through feedback loop filter 150, which may condition the error signal to achieve a stable lock. The conditioned error signal may be provided to an input of frequency control 110. When the feedback loop is active, the frequency of the first light source 105 (f₁) may follow the frequency reference point established by the phase difference between first waveguide 120 (e.g., the specified frequency, f₂, of first FDOE 130) and second waveguide 125 (e.g., the specified frequency, f₃, of second FDOE 135).

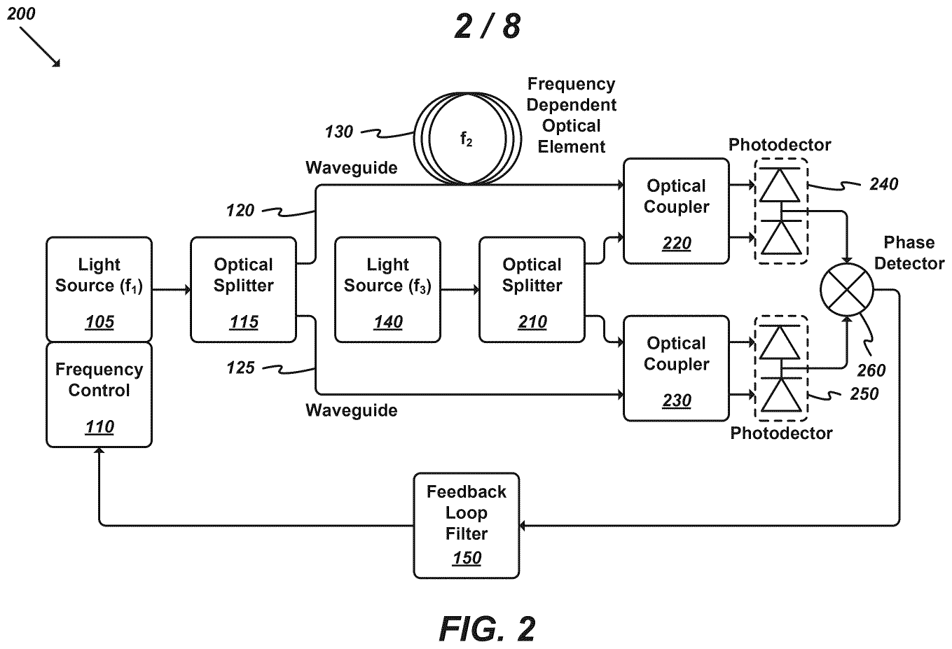

FIG. 2 illustrates a schematic block diagram of a second COMPACT stabilizer 200 of one or more embodiments described herein. As shown, the second COMPACT stabilizer 200 may include a first light source 105, a frequency control 110, a first optical splitter 115, a first waveguide 120, a second waveguide 125, a first FDOE 130, a second light source 140, a second optical splitter 210, a first optical coupler 220, a second optical coupler 230, a first photodetector 240, a second photodetector 250, a phase detector 260, and a feedback loop filter 150. Heterodyne optical phase detector 145 may include or utilize second optical splitter 210, first optical coupler 220, second optical coupler 230, first photodetector 240, second photodetector 250, and/or phase detector 260.

COMPACT stabilizer 200 may be implemented by, via, and/or otherwise utilizing various components, devices, systems, and/or other resources as appropriate. In some embodiments, the components associated with COMPACT stabilizer 200 may be implemented as components of a PIC.

Second optical splitter 210 may be similar to first optical splitter 115.

First optical coupler 220 may allow coupling of light waves and/or associated signals (e.g., by summing one or more input waves or signals). Second optical coupler 230 may be similar to first optical coupler 220.

First photodetector 240 may be able to sense light and/or other electromagnetic radiation. Second photodetector 250 may be similar to first photodetector 240.

Phase detector 260 may generate a signal that represents the difference in phase between two input signals. The phase detector 260 may include any combination of analog devices, such as but not limited to a double balanced mixer, and/or digital devices, such as, but not limited to an analog-to-digital converter that samples input signals, a microprocessor or field programmable gate array (FPGA) that operates to compute the phase difference between input signals, and a digital-to-analog converter that generates an output signal that indicates the phase difference computed by the microprocessor and/or FPGA.

In the example COMPACT stabilizer 200, the frequency of the first light source 105 (f₁) may be locked to the frequency of the first FDOE 130 (f₂). The frequency of the first light source 105 (f₁) may be tuned via modulation of an internal light source parameter (e.g., a laser pump current or laser cavity length) or an external modulator (e.g., an acousto-optic frequency shifter).

The first light source 105 may be split by the first optical splitter 115 such that a portion of the light travels via first waveguide 120 and another portion of the light travels via second waveguide 125. The amplitude and phase of the light traveling via first waveguide 120 may be altered by first FDOE 130 by an amount that depends on the frequency of the first light source 105 (f₁). The amplitude and phase of the light traveling via second waveguide 125 remain unaltered.

If the optical phase difference between the light traveling via the first waveguide 120 and the second waveguide 125 were quantified the signal would pass zero at certain frequencies. These zero crossings would correspond to the frequency reference points of the first FDOE 130 and constitute points where an active feedback loop can be closed to lock the frequency of the first light source 105 (f₁). When the first FDOE 130 is a resonant device, the amplitude of the light traveling via the first waveguide 120 usually also approaches zero at the frequency reference points, which enhances the signal in the feedback loop.

The second light source 140 may be used to detect the optical phase difference between the light traveling via first waveguide 120 and second waveguide 125. The second light source 140 may generate an optical signal to be used as a temporary optical phase reference and for additional signal gain. The light from the second light source 140 may be split between two optical paths which are sent to first optical coupler 220 and second optical coupler 230 to be coupled with the light from first waveguide 120 and second waveguide 125 as shown. The outputs of first optical coupler 220 may be provided to first photodetector 240 and the outputs of second optical coupler 230 may be provided to second photodetector 250, in order to down-convert the light to an electronic signal. This method of down-converting the light preserves the optical phase as well as the amplitude, so that the optical phase difference between first waveguide 120 and second waveguide 125 may be measured by comparing the phase difference between the electronic signals provided by first photodetector 240 and second photodetector 250.

Phase detector 260 (e.g., an electronic mixer) may receive the electronic signals provided by first photodetector 240 and second photodetector 250 and generate an output that is proportional to the phase difference of the received signals. Crucially, because the second light source 140 is used to down-convert both of the electronic signals, any contribution to the output signal from the second light source 140 is canceled out. The phase detector 260 may provide an error signal output, which may be passed through feedback loop filter 150, which may condition the error signal to achieve a stable lock. The conditioned error signal may be provided to an input of frequency control 110. When the feedback loop is active, the frequency of the first light source 105 (f₁) may follow the frequency reference point established by the phase difference between first waveguide 120 and second waveguide 125 (e.g., the frequency of first FDOE 130).

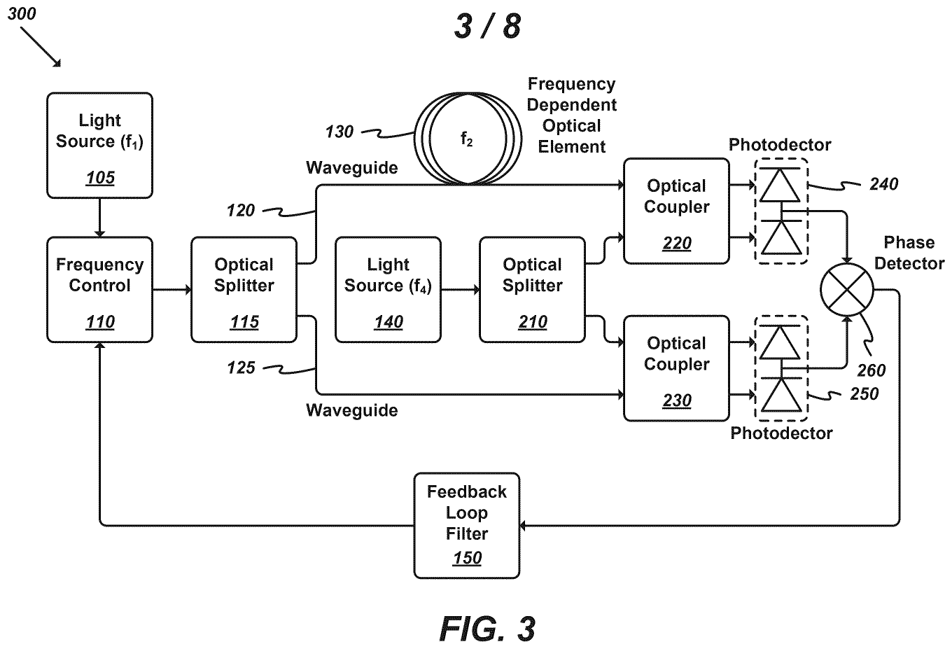

FIG. 3 illustrates a schematic block diagram of a third COMPACT stabilizer 300 of one or more embodiments described herein. As shown, the COMPACT stabilizer 300 may be similar to COMPACT stabilizer 200, but the frequency control 110 receives the output of light source 105 rather than controlling the output produced by the light source 105. As with COMPACT stabilizer 200, when the feedback loop of compact stabilizer 200 is active, the frequency of the first light source 105 (f₁) may follow the frequency reference point established by the phase difference between first waveguide 120 and second waveguide 125 (e.g., the frequency of first FDOE 130).

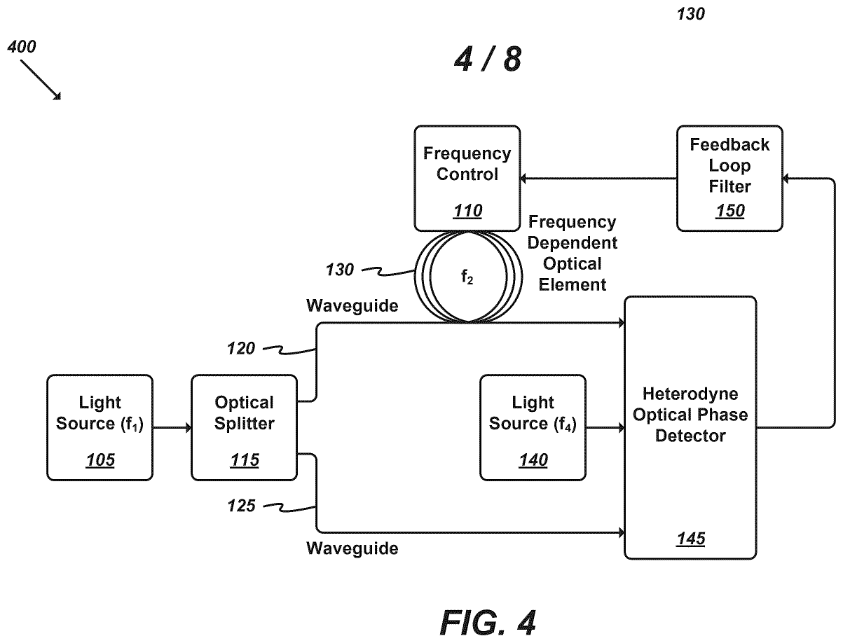

FIG. 4 illustrates a schematic block diagram of a fourth COMPACT stabilizer 400 of one or more embodiments described herein. As shown, the COMPACT stabilizer 400 may be similar to COMPACT stabilizer 200, but the frequency control 110 is associated with the first FDOE 130. Analogously to COMPACT stabilizer 200, when the feedback loop of compact stabilizer 300 is active, the frequency of the first FDOE 130 may follow the frequency reference point established by the phase difference between first waveguide 120 and second waveguide 125 (e.g., the frequency of first light source 105).

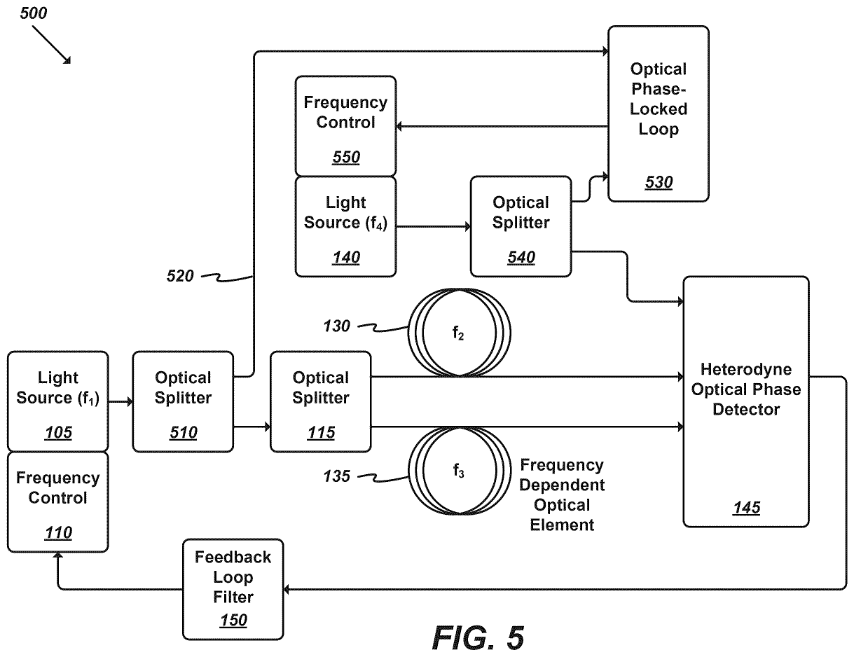

FIG. 5 illustrates a schematic block diagram of a fifth COMPACT stabilizer 500 of one or more embodiments described herein. As shown, the COMPACT stabilizer 500 may be similar to COMPACT stabilizer 100, and may further include a third optical splitter 510, third waveguide 520, an optical phase-locked loop (OPLL) 530, a fourth optical splitter 540, and second frequency control 550.

Third optical splitter 510 and fourth optical splitter 540 may be similar to first optical splitter 115 and second optical splitter 210. Third waveguide 520 may be similar to second waveguide 125. Second frequency control 550 may be similar to frequency control 110. OPLL 530 may synchronize the relative phases of two light fields (e.g., the light from waveguide 520 and optical splitter 540) and produce an output signal that is provided to frequency control 550.

FIG. 4 illustrates a schematic block diagram of a sixth COMPACT stabilizer 600 of one or more embodiments described herein. As shown, the COMPACT stabilizer 600 may be similar to COMPACT stabilizer 200, and may further include a third optical splitter 510, third waveguide 520, fourth optical splitter 540, third optical coupler 620, third photodetector 630, second phase detector 640, radio frequency (RF) source 650, second feedback loop filter 660, and second frequency control 550.

OPLL 530 may include or utilize third optical coupler 620, third photodetector 630, second phase detector 640, and/or RF source 650 in some embodiments.

Third optical coupler 620 may be similar to first optical coupler 220 and second optical coupler 230. Third photodetector 630 may be similar to first photodetector 240 and second photodetector 250. Second phase detector 640 may be similar to phase detector 260. RF source 650 may be, include, and/or otherwise utilize electronic components that are able to generate an RF signal and pass the signal to second phase detector 640. Second feedback loop filter 660 may be similar to feedback loop filter 150.

When the feedback loop of compact stabilizer 600 is active, the frequency of the first FDOE 130 may follow the frequency reference point established by the phase difference between first waveguide 120 and second waveguide 125 (e.g., the frequency of first light source 105) with an offset established by the frequency of the RF source 650.

The feedback loop may be implemented in various different ways in different embodiments. For instance, if the output of first feedback loop filter 150 is passed to second frequency control 550 and the output of second feedback loop filter 660 is passed to frequency control 110, the frequency of the first FDOE 130 may still follow the frequency reference point established by the phase difference between first waveguide 120 and second waveguide 125 (e.g., the frequency of first light source 105) with an offset established by the frequency of the RF source 650. As another example, first light source 105 may be locked to second light source 140 (or vice-versa) or other feedback may be provided to the second light source 140 (and/or second frequency control 550). Some embodiments may implement or utilize elements such as modulated self-injection-locked (SIL) sources or other components.

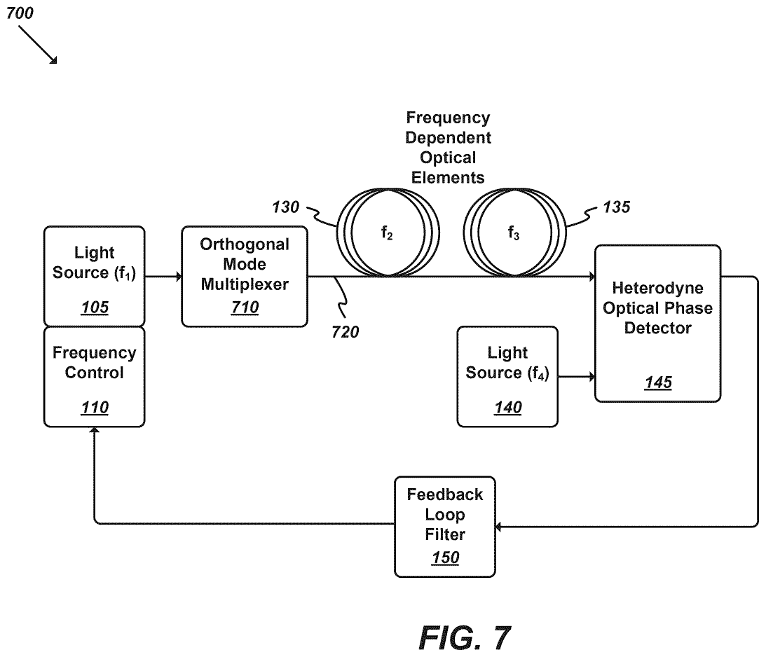

FIG. 7 illustrates a schematic block diagram of a seventh COMPACT stabilizer 700 of one or more embodiments described herein. As shown, the COMPACT stabilizer 700 may be similar to COMPACT stabilizer 200 and may include an orthogonal mode multiplexer 710 and a waveguide 720.

Orthogonal mode multiplexer 710 may generate a polarized output. Orthogonal mode multiplexer 710 may operate across multiple frequency bands. For example, orthogonal mode multiplexer 710 may generate an output including transverse electric (TE) and transverse magnetic (TM) components.

As shown, in this example, orthogonal model multiplexer 710 may receive an output of first light source 105 and may pass the output along waveguide 720, where waveguide 720 may include first FDOE 130 and second FDOE 135 in series. The output of waveguide 720 may be passed to heterodyne optical phase detector 145.

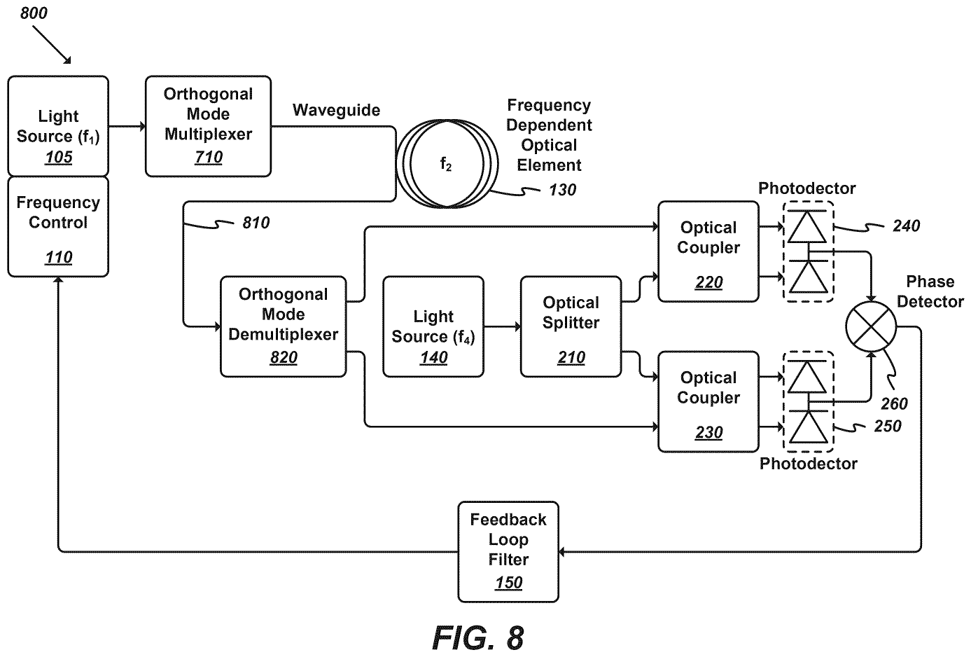

FIG. 8 illustrates a schematic block diagram of an eighth COMPACT stabilizer 800 of one or more embodiments described herein. As shown, the COMPACT stabilizer 800 may be similar to COMPACT stabilizer 200 and may include a waveguide 810 and an orthogonal mode demultiplexer 820.

Orthogonal mode demultiplexer 820 may separate the signals received via waveguide 810 from orthogonal mode multiplexer 710, such as by separating the received signal into TE and TM outputs.

Waveguide 810 may be similar to first waveguide 120 and second waveguide 125 and may include FDOE 130 as shown.

In this example, eighth COMPACT stabilizer 800 includes an orthogonal mode multiplexer 710 and an orthogonal mode demultiplexer 820, as shown. Light from first light source 105 may be split between two orthogonal modes of the same physical waveguide 810 by the orthogonal mode multiplexer 710. Orthogonal modes (e.g., transverse spatial modes, polarization modes, etc.) do not interact with each other inside the waveguide 810, and FDOE 130 may be configured such that the FDOE 130 interacts with only one of the orthogonal modes. Orthogonal mode demultiplexer 820 may split out the two orthogonal modes, which may be down-converted to electronic signals as described above. The eighth COMPACT stabilizer 800 may operate in a similar manner to second COMPACT stabilizer 200, except that the functionality of first waveguide 120 and second waveguide 125 is provided via the same physical waveguide 810, which reduces the impact of environmental noise and allows for the optical path to be much longer (enabling, for example, fiber-optic implementations of COMPACT stabilization techniques).

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A coherent modulation-free photonic active (COMPACT) stabilizer comprising:
a first light source;
a first optical splitter that receives an output of the first light source and generates a set of optical output signals;
a first frequency dependent optical element (FDOE) which receives a first output signal of the first optical splitter and imparts a frequency-dependent change in phase and/or amplitude of the first output signal;
a second FDOE which receives a second output signal of the first optical splitter and imparts a frequency-dependent change in phase and/or amplitude of the second output signal;
a second light source; and
a heterodyne optical phase detector that receives an output of the first FDOE, an output of the second FDOE, and an output of the second light source and generates an output signal that indicates a phase difference between the output of the first FDOE and the output of the second FDOE.

2. The COMPACT stabilizer of claim 1, wherein at least one of the first FDOE and the second FDOE is an optical resonator.

3. The COMPACT stabilizer of claim 1, wherein at least one of the first FDOE and the second FDOE is an optical delay line.

4. The COMPACT stabilizer of claim 1, wherein at least one of the first FDOE and the second FDOE is a short optical path, which imparts a minimal frequency-dependent change in phase and/or amplitude.

5. The COMPACT stabilizer of claim 1, wherein the heterodyne optical phase detector comprises:
a second optical splitter that receives an output of the second light source and generates a second set of optical output signals;
a first optical coupler that receives an output of the first FDOE and a first output signal from the second optical splitter;
a second optical coupler that receives an output of the second FDOE and a second output signal from the second optical splitter;
a first photodetector that receives one or more outputs of the first optical coupler;
a second photodetector that receives one or more outputs of the second optical coupler; and
a phase detector that receives an output of the first photodetector and an output of the second photodetector and generates a phase output signal indicating a phase difference between the output of the first photodetector and the output of the second photodetector.

6. The COMPACT stabilizer of claim 1, wherein the frequency of the first light source matches a frequency of the first FDOE, and wherein a frequency of the second light source is different than the frequency of the first light source.

7. The COMPACT stabilizer of claim 1, wherein the second light source is generated from the first light source by passing the first light source through an acousto-optic modulator that generates a frequency-shifted output.

8. The COMPACT stabilizer of claim 1 further comprising a feedback loop filter that receives an output of the heterodyne optical phase detector and generates at least one control signal which at least partly controls a frequency of the first light source, the second light source, the first FDOE, or the second FDOE.

9. The COMPACT stabilizer of claim 8 further comprising a second frequency control that at least partly controls a frequency of the first FDOE or the second FDOE based on the at least one control signal generated by the feedback loop filter.

10. The COMPACT stabilizer of claim 8 further comprising a first frequency control that at least partly controls an output frequency of the first light source or the second light source based on the at least one control signal generated by the feedback loop filter.

11. The COMPACT stabilizer of claim 10, wherein the first frequency control controls an output frequency of the first light source or the second light source by operating on an internal or intrinsic parameter of the first light source or the second light source.

12. The COMPACT stabilizer of claim 10, wherein the first frequency control effectively controls an output frequency of the first light source or the second light source by receiving an output of the first light source or the second light source and providing a frequency-shifted output based at least partly on the at least one control signal generated by the feedback loop filter.

13. The COMPACT stabilizer of claim 1 further comprising:
a second optical splitter that receives an output of the first light source and generates a second set of optical output signals, wherein at least one signal from the second set of optical signals is provided to an input of the first optical splitter;
a third optical splitter that receives the output of the second light source and generates a third set of optical output signals, wherein at least one signal from the second set of optical signals is provided to an input of the heterodyne optical phase detector;
an optical phase locked loop (OPLL), which receives at least one signal from the third set of optical signals and at least one signal from the fourth set of optical signals and generates an output signal indicating a phase difference between the first light source and the second light source; and
a third frequency control that receives the output signal from the OPLL and generates at least one control signal that at least partly controls a frequency of the second light source.

14. The COMPACT stabilizer of claim 13, wherein the OPLL comprises:
a third optical coupler that receives an output from the second optical splitter and an output from the third optical splitter and generates a set of output signals;
a third photodetector that receives one or more output signals from the set of output signals generated by the third optical coupler and generates a signal indicating a frequency difference between the output from the second optical splitter and the output from the third optical splitter;
a frequency source; and
a phase detector that receives outputs from the third photodetector and the frequency source and generates a signal indicating a phase difference.

15. The COMPACT stabilizer of claim 14 further comprising a feedback loop filter that receives the output signal generated by the OPLL and generates at least one stabilized control signal that at least partly directs operations of the third frequency control.

16. The COMPACT stabilizer of claim 1 wherein:
the splitter is an orthogonal mode multiplexer that receives an output of the first light source and generates a set of optical output signals, which are orthogonal modes such that the set of optical output signals follow the same or similar physical paths but are separated, and
the first FDOE and the second FDOE are arranged in series, such that the first FDOE receives multiplexed orthogonal modes and imparts a frequency-dependent amplitude and/or phase change that primarily affects a first orthogonal mode, and such that second FDOE receives the multiplexed output of the first FDOE and imparts a frequency-dependent amplitude and/or phase change that primarily affects a second orthogonal mode.

17. The COMPACT stabilizer of claim 16, wherein the first FDOE and the second FDOE are configured such that the frequency-dependent amplitude and/or phase change of the first output signal is different than the frequency-dependent amplitude and/or phase change of the second output signal.

18. The COMPACT stabilizer of claim 16, wherein the heterodyne optical phase detector comprises:
a second optical splitter, that receives an output of the second light source and generates a second set of optical output signals;
an orthogonal mode demultiplexer that receives an output of the first FDOE and an output of the second FDOE, and generates at least one output optical signal corresponding to the first FDOE and at least one output optical signal corresponding to the second FDOE.
a first optical coupler that receives a first output signal from the second optical splitter and an output of the orthogonal mode demultiplexer that corresponds to the at least one output optical signal corresponding to the first FDOE;
a second optical coupler that receives a second output signal from the second optical splitter and an output of the orthogonal mode demultiplexer that corresponds to the at least one output optical signal corresponding to the second FDOE;
a first photodetector that receives one or more outputs of the first optical coupler;
a second photodetector that receives one or more outputs of the second optical coupler; and
a phase detector that receives an output of the first photodetector and an output of the second photodetector and generates a phase output signal indicating a phase difference between the output of the first photodetector and the output of the second photodetector.
